(19) United States
(12) Patent Application Publication
(10) Pub. No.: US 2021/0109263 A1
(43) Pub. Date: Apr. 15, 2021

(54) HEAT-INSULATING AND ENERGY-SAVING FILM

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Chia-Ho Cheng, TAIPEI (TW)

(21) Appl. No.: 16/893,606

(22) Filed: Jun. 5, 2020

(30) Foreign Application Priority Data
Oct. 15, 2019 (TW) 108137052

(51) Int. Cl. G02B 5/20; G02B 5/22; B32B 7/12

(52) U.S. Cl. CPC G02B 5/208; E06B 3/6715; B32B 7/12; G02B 5/223

(57) ABSTRACT

A heat-insulating energy-saving film includes a substrate, an infrared blocking layer and an antifouling protective layer. The infrared blocking layer is disposed on a surface of the substrate and the antifouling protective layer is disposed on the infrared blocking layer, in which the infrared blocking layer has a plurality of composite tungsten oxide particles uniformly distributed therein. The composite tungsten oxide particles of the infrared blocking layer are each doped with specific metal and non-metal elements, such that the infrared cut rate of the infrared blocking layer is capable of reaching 99%.

### CROSS-REFERENCE TO RELATED PATENT APPLICATION

This application claims the benefit of priority to Taiwan Patent Application No. 108137052, filed on Oct. 15, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a heat-insulating structure, and more particularly to a heat-insulating energy-saving film having antifouling and protective functions.

### BACKGROUND OF THE DISCLOSURE

Due to the influence of global warming, the demand for heat insulation and energy conservation is increasing with each passing day. For example, when sunlight enters a room through glass windows, infrared radiation in sunlight may cause an increase in room temperature, thus a ventilating or cooling device is needed to reduce discomfort from high room temperatures. According to statistical results, in summertime, solar radiation entering a room through its windows significantly increases the energy consumption of an air conditioner cooling the room. It can be seen that the heat-insulating performance of the glass window would affect the room temperature of a building. Similarly, the heat-insulating performance of windshields or windows is one of the main factors affecting the interior temperature of an automobile.

One common method of heat insulation is to arrange a metal reflecting layer or a dyed layer on a target object. Although the metal reflecting layer can reflect infrared and ultraviolet, its related products may cause light pollution. Although the dyed layer can absorb infrared, the heat-insulating performance thereof needs to be improved and may gradually fade. In addition, another method of heat insulation uses a multilayered film structure formed by one or more metal-plated layers (e.g. silver-plated layers) and one or more dielectric layers. The multilayered film structure can allow the transmission of visible light and block infrared radiation by optical interference. However, said another method requires a large investment in equipment, incurs high material costs, and has a low product yield. In addition, a conventional low-emissivity glass (low-e) glass still has room for improving its heat-insulating effect, and cannot be used for decorative purposes. Also, glass products are fragile and cannot be reworked, which causes many inconveniences in application.

Since modern buildings employ a large number of glass windows and glass exterior designs, such as those adopting glass curtains, and since the use of cars has been quickly growing, the development of new high performance insulation materials has become a very important and urgent issue.

### SUMMARY OF THE DISCLOSURE

In response to the above-referenced technical inadequacies, the present disclosure provides a heat-insulating energy-saving film that not only has high light transmittance and high infrared cut rate but also has antifouling and protection functions and good use flexibility.

In one aspect, the present disclosure provides a heat-insulating energy-saving film that includes a substrate, an infrared blocking layer and an antifouling protective layer. The substrate has a first surface and a second surface opposite to the first surface. The infrared blocking layer is disposed on the first surface of the substrate and the antifouling protective layer is disposed on the infrared blocking layer. The infrared blocking layer has a plurality of composite tungsten oxide particles uniformly distributed therein. The composite tungsten oxide particles have the following formula of: CsₓM_{y}WO_{3-z}N_{c}, wherein Cs represents cesium, M represents tin (Sn), antimony (Sb) or bismuth (Bi), W represents tungsten, O represents oxygen, and N represents fluorine (F), chlorine (Cl) or bromine (Br)

In certain embodiments, the antifouling protective layer contains 40% to 90% by weight of a fluoropolymer that is at least one selected from of polyvinylidene fluoride, polytetrafluoroethylene and polyvinyl fluoride.

In certain embodiments, the antifouling protective layer contains 0.3% to 15% by weight of a colorant.

In certain embodiments, the average particle diameter of the composite tungsten oxide particles is between 10 nm and 90 nm. The composite tungsten oxide particles are present in an amount between 5% and 25% by weight of the total weight of the infrared blocking layer.

In certain embodiments, the substrate is formed from a polyester resin. The infrared blocking layer is formed from a UV-curable resin composition with the composite tungsten oxide particles.

In certain embodiments, the substrate has a thickness between 23 μm and 125 μm. The infrared blocking layer has a thickness between 2 μm and 10 μm. The antifouling protective layer has a thickness between 12 μm and 50 μm.

In certain embodiments, the heat-insulating energy-saving film further includes a first bonding layer disposed between the infrared blocking layer and the antifouling protective layer. The antifouling protective layer is fixed in position to the infrared blocking layer by the first bonding layer.

In certain embodiments, the first bonding layer has a thickness between 5 μm and 25 μm.

In certain embodiments, the first bonding layer contains 2% to 10% by weight of an ultraviolet absorber.

In certain embodiments, the heat-insulating energy-saving film further includes a second bonding layer disposed on the second surface of the substrate.

In certain embodiments, the second bonding layer has a thickness between 5 μm and 25 μm.

In certain embodiments, the second bonding layer contains 0.5% to 8% by weight of an ultraviolet absorber.

One of the effects of the present disclosure is that the heat-insulating energy-saving film can meet the application requirements of heat-insulating products, including high heat insulation performance and sufficient visibility, and provides antifouling and external impact resistant functions required for a target application, by virtue of “the infrared blocking layer is disposed on the first surface of the substrate and the antifouling protective layer is disposed on the infrared blocking layer” and “the infrared blocking layer has a plurality of composite tungsten oxide particles uniformly distributed therein, which are each doped with specific metal and non-metal elements.” The heat-insulating energy-saving film has a visible light transmittance reaching 70% and an infrared cut rate reaching 99%.

The heat-insulating energy-saving film of the present disclosure can reduce the effect of an outdoor environment on an indoor temperature under irradiation of strong sunlight, and therefore it contributes greatly to energy saving and carbon footprint reduction. In addition, the heat-insulating energy-saving film of the present disclosure is easy to be used and reworked.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a heat-insulating energy-saving film according to a first embodiment of the present disclosure.

FIG. 2 is another schematic view of the heat-insulating energy-saving film according to the first embodiment of the present disclosure.

FIG. 3 is still another schematic view of the heat-insulating energy-saving film according to the first embodiment of the present disclosure.

FIG. 4 is still another schematic view of the heat-insulating energy-saving film according to the first embodiment of the present disclosure.

FIG. 5 is a schematic view of a heat-insulating energy-saving film according to a second embodiment of the present disclosure.

FIG. 6 is another schematic view of the heat-insulating energy-saving film according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

Unless defined otherwise, all technical and scientific terms used herein have the same meanings as commonly understood by one of ordinary skill in the art to which this invention belongs. As used herein, the singular forms “a,” “an,” and “the,” are intended to include the plural forms.

Unless indicated otherwise, all percentages disclosed herein are in weight percent. The upper and lower limits of these smaller ranges may independently be included in the smaller ranges and are also encompassed within the disclosure, subject to any specifically excluded limit in the stated range.

### First Embodiment

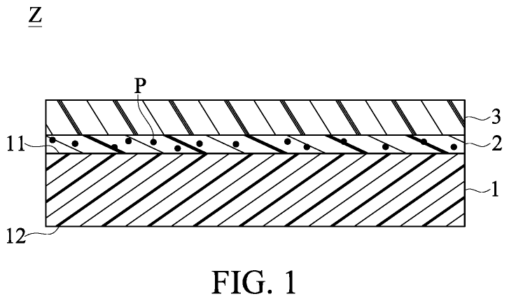

Referring to FIG. 1, a first embodiment of the present disclosure provides a heat-insulating energy-saving film Z that mainly includes a substrate 1, an infrared blocking layer 2, and an antifouling protective layer 3. The substrate 1 has a first surface 11 (e.g., a top surface) and a second surface 12 (e.g., a bottom surface) opposite to the first surface 11. The infrared blocking layer 2 is disposed on the first surface 11 of the substrate 1 and has a plurality of composite tungsten oxide particles P uniformly distributed therein. The antifouling protective layer 3 is disposed on the infrared blocking layer 2.

In use, the heat-insulating energy-saving film Z can be attached to a surface of a target object (not shown) that requires a balance between visibility and heat-insulating effect, so as to block infrared light and allow the transmission of visible light by the infrared blocking layer 2. The target object is, for example, a glass window or a glass facade of a building, a front or rear windshield, or a left side or right side window glass of a car. Therefore, a solar radiation effect on the indoor temperature can be reduced, thereby reducing energy consumption associated therewith. It is worth mentioning that, the antifouling protective layer 3 is capable of resisting impact to protect the target object from being damaged. In addition, the antifouling protective layer 3 can prevent adhesion of dirt that may result in a decrease in film visibility.

More specifically, the substrate 1 is used to carry the infrared blocking layer 2 and the antifouling protective layer 3 and to arrange them on a specific surface area of the target object. The substrate 1 has flexibility such that the use flexibility of the heat-insulating energy-saving film Z can be increased. For example, the heat-insulating energy-saving film Z can adapt to different three-dimensional shapes of the target object, i.e., it can be smoothly attached to the target object. Furthermore, the substrate 1 can provide good support to the infrared blocking layer 2 and the antifouling protective layer 3 so as to enable them to achieve desired effects. In the present embodiment, the substrate 1 is a plastic substrate having high transmittance such as a polyester resin substrate. The thickness of the substrate 1 can be between 23 μm and 125 μm, and preferably between 23 μm and 75 μm. Examples of the material of the substrate 1 include polyethylene terephthalate (PET), polyethylene naphthalate (PEN), polyvinyl chloride (PVC), polypropylene (PP), polycarbonate (PC), polyethylene (PE) and nylon (Nylon). However, the above-described details are merely exemplary, and are not intended to limit the present disclosure.

The infrared blocking layer 2 is formed from a resin composition and is in the form of a continuous layer. The resin composition mainly includes a molding resin and a plurality of composite tungsten oxide particles P. In the present embodiment, the molding resin can be a UV-curable resin, the examples of which include an acrylic resin and modified acrylic resins having different functional groups. The composite tungsten oxide particles P have the following formula: CsₓM_{y}WO_{3-z}N_{c}; wherein Cs represents cesium, M represents tin (Sn), antimony (Sb) or bismuth (Bi), W represents tungsten, O represents oxygen, and N represents fluorine (F), chlorine (Cl) or bromine (Br), preferably represents fluorine (F) or bromine (Br); and x, y, x and c all are positive numbers and meet the following conditions: x≤1.0, y≤1.0, y/x≤1.0, z≤0.6, and c≤0.1. The method for forming the infrared blocking layer 2 includes: mixing the composite tungsten oxide particles P into the molding resin; applying the resulting resin composition to the first surface 11 of the substrate 1; and curing the resin composition. However, the above-described details are merely exemplary, and are not intended to limit the present disclosure.

According to test results, the infrared blocking layer 2 has a visible light transmittance of at least 65%, preferably reaching 70%, and an infrared cut rate of at least 90%, and preferably reaching 99%. It should be noted that, the composite tungsten oxide particles P are each doped with specific metal and non-metal elements. The metal elements can make up for the deficiency of the infrared-absorbing ability of tungsten oxide, for example, can increase the absorption of infrared light at a wavelength between 850 nm and 2500 nm. The non-metal metal elements can increase the weather resistance of the infrared blocking layer 2.

Test of Visible Light Transmittance (VLT %):

A testing device (model name “TC-HIII DPK”, produced by Tokyo Denshoku Co., Ltd., Japan) was used to test the visible light transmittance of the infrared blocking layer 2 in accordance with JIS K7705 standard. Therefore, the higher the visible light transmittance, the better the transparency of the infrared blocking layer 2 is.

Test of Infrared Cut Rate (IR cut %):

A testing device (model name “LT-3000”, produced by HOYA Corporation, Japan) was used to test the infrared light transmittance of the infrared blocking layer 2 in accordance with JIS R3106 standard. The infrared cut rate of the infrared blocking layer 2 was obtained by subtracting its infrared light transmittance from 100%. Therefore, the better the heat-insulating effect, the higher the infrared cut rate of the infrared blocking layer 2 is.

In consideration of production cost and heat insulation efficiency, the thickness of the infrared blocking layer 2 can be between 2 μm and 10 μm, in which the average particle size of the composite tungsten oxide particles P can be between 10 nm and 90 nm, and the composite tungsten oxide particles P are present in an amount between 5% and 25% by weight of the total weight of the infrared blocking layer 2. In certain embodiments, the average particle size of the composite tungsten oxide particles P can be 20 nm, 30 nm, 40 nm, 50 nm, 60 nm, 70 nm or 80 nm. The present amount of the composite tungsten oxide particles P can be 10%, 15% or 20% by weight.

The antifouling protective layer 3 can be directly formed on the infrared blocking layer 2 to provide antifouling and external impact resistant functions. In the present embodiment, the thickness of the antifouling protective layer 3 can be between 12 μm and 50 μm, and preferably between 12 μm and 20 μm. Furthermore, the antifouling protective layer 3 contains 40% to 90% by weight of a fluoropolymer. The fluoropolymer is at least one selected from of polyvinylidene fluoride (PVDF), polytetrafluoroethylene (PTFE) and polyvinyl fluoride (PVF), preferably PVDF or PTFE. It should be noted that, when the content of the fluoropolymer falls within the above-mentioned range, the antifouling protective layer 3 also has an excellent weather resistance. In certain embodiments, the content of the fluoropolymer can be 75%, 80% or 85% by weight.

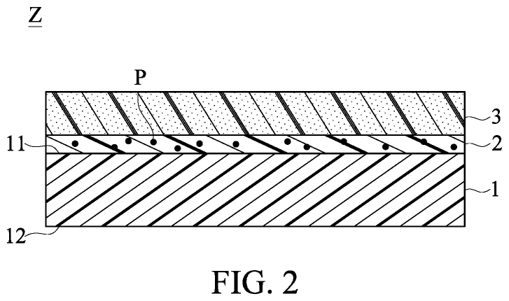

Referring to FIG. 2, the antifouling protective layer 3 can contain 0.3% to 15% by weight of a colorant so as to have a specific color appearance. In certain embodiments, the colorant is a black pigment to allow the antifouling protective layer 3 to have a black appearance, so as to increase the shielding property of the antifouling protective layer 3. The black pigment is carbon black, titanium black or the combination thereof, and is uniformly distributed in the antifouling protective layer 3 in the form of particles. However, the above-described details are merely exemplary, and are not intended to limit the present disclosure.

The antifouling protective layer 3 can contain 10% to 45% by weight of an auxiliary polymer such as, but is not limited to, polymethyl methacrylate (PMMA). When the auxiliary polymer is added into the antifouling protective layer 3, the present amount of the fluoropolymer would be slightly decreased and therefore the production cost would be reduced.

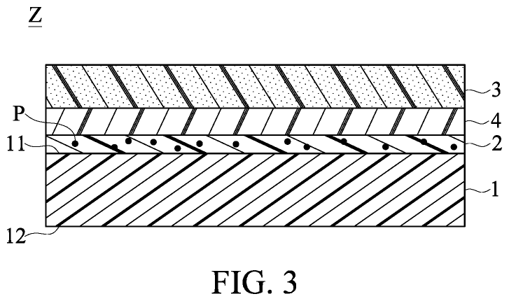

Referring to FIG. 3, the heat-insulating energy-saving film Z can further include a first bonding layer 4 according to particular requirements, which is disposed between the infrared blocking layer 2 and the antifouling protective layer 3 and is in the form of a continuous layer. That is, the antifouling protective layer 3 is fixed in position to the infrared blocking layer 2 by the first bonding layer 4. In the present embodiment, the first bonding layer 4 contains an adhesive component that is selected from at least one of polyurethane, acrylic, polyester, polyvinyl alcohol and ethylene vinyl acetate. The thickness of the first bonding layer 4 can be between 5 μm and 25 μm. However, the above-described details are merely exemplary, and are not intended to limit the present disclosure.

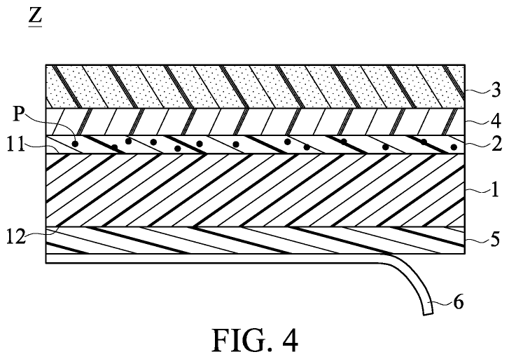

Referring to FIG. 4, in consideration of practicality, the heat-insulating energy-saving film Z can further include a second bonding layer 5 and a temporary cover layer 6. The second bonding layer 5 is disposed on the second surface 12 of the substrate 1, and is in the form of a continuous layer. The temporary cover layer 6 is covered on a surface of the second bonding layer 5. In use, the heat-insulating energy-saving film Z can be directly attached onto a surface of the target object by the second bonding layer 5 after removing the temporary cover layer 6 from the surface of the second bonding layer 5. The temporary cover layer 6, before being removed, can prevent the surface of the second bonding layer 5 from coming in contact with dirt, which may cause a decrease in bonding strength. In the present embodiment, the second bonding layer 5 contains an adhesive component that is selected from at least one of polyurethane, acrylic, polyester, polyvinyl alcohol and ethylene vinyl acetate. The thickness of the second bonding layer 5 can be between 5 μm and 25 μm. The material of the temporary cover layer 6 is not particularly limited insofar as the temporary cover layer 6 is stably attached to the surface of the second bonding layer 5. However, the above-described details are merely exemplary, and are not intended to limit the present disclosure.

### Second Embodiment

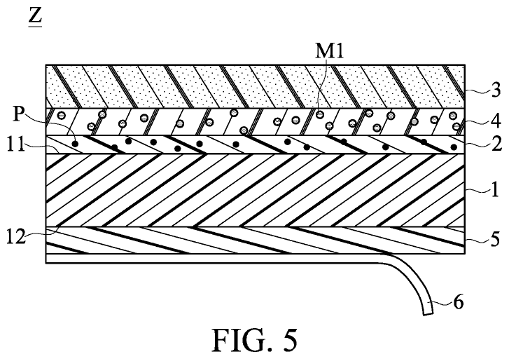

Referring to FIG. 5, a second embodiment of the present disclosure provides a heat-insulating energy-saving film Z that mainly includes a substrate 1, an infrared blocking layer 2, an antifouling protective layer 3 and a first bonding layer 4. The substrate 1 has a first surface 11 (e.g., a top surface) and a second surface 12 (e.g., a bottom surface) opposite to the first surface 11. The infrared blocking layer 2 is disposed on the first surface 11 of the substrate 1 and has a plurality of composite tungsten oxide particles P uniformly distributed therein. The antifouling protective layer 3 is disposed on the infrared blocking layer 2. The first bonding layer 4 is disposed between the infrared blocking layer 2 and the antifouling protective layer 3, and contains 2% to 10% by weight of an ultraviolet absorber M1. Therefore, the heat-insulating energy-saving film Z can have an ultraviolet blocking ability.

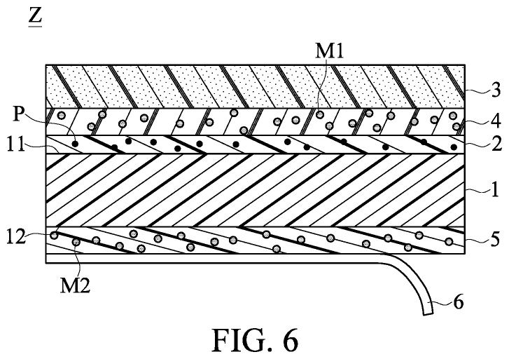

Referring to FIG. 6, the heat-insulating energy-saving film Z can further include a second bonding layer 5 and a temporary cover layer 6. The second bonding layer 5 is disposed on the second surface 12 of the substrate 1 and contains 0.5% to 8% by weight of an ultraviolet absorber M2. The temporary cover layer 6 is covered on a surface of the second bonding layer 5. In the present embodiment, the content of the ultraviolet absorber M1 of the first bonding layer 4 can be the same as or different from the content of the ultraviolet absorber M2 of the second bonding layer 5.

The method for forming the first bonding layer 4 includes: mixing the ultraviolet absorber M1 into an adhesive component; applying the resulting material to a surface of the infrared blocking layer 2; and curing the resulting material. Similarly, the method for forming the second bonding layer 5 includes: mixing the ultraviolet absorber M2 into an adhesive component; applying the resulting material to the second surface 12 of the substrate 1; and curing the resulting material. The adhesive component is, for example, polyurethane, acrylic, polyester, polyvinyl alcohol, ethylene vinyl acetate, or any combination thereof. Each of the ultraviolet absorber M1 and the ultraviolet absorber M2 is, for example, nickel quenchers, oxalic anilines, benzotriazoles, benzoic acid esters, benzophenones, or any combination thereof. However, the above-described details are merely exemplary, and are not intended to limit the present disclosure. Other implementation details of the heat-insulating energy-saving film Z have been described in the first embodiment, and will not be reiterated herein.

One of the effects of the present disclosure is that the heat-insulating energy-saving film can meet the application requirements of heat-insulating products, including high heat insulation performance and sufficient visibility, and provides antifouling and external impact resistant functions required for a target application, by virtue of “the infrared blocking layer is disposed on the first surface of the substrate and the antifouling protective layer is disposed on the infrared blocking layer” and “the infrared blocking layer has a plurality of composite tungsten oxide particles uniformly distributed therein, which are each doped with specific metal and non-metal elements.” The heat-insulating energy-saving film has a visible light transmittance reaching 70% and an infrared cut rate reaching 99%.

Furthermore, the heat-insulating energy-saving film can include a first bonding layer for stably bonding together the antifouling protective layer and the infrared blocking layer. The first bonding layer can contain 2% to 10% by weight of an ultraviolet absorber such that the heat-insulating energy-saving film has an ultraviolet blocking ability in practical applications.

In addition, the heat-insulating energy-saving film can include a second bonding layer disposed on the second surface of the substrate, such that it can be directly attached onto a surface of a target object by the second bonding layer, thereby increasing the convenience of use. According to particular requirements, the second bonding layer can contain 0.5% to 8% by weight of an ultraviolet absorber to increase the ultraviolet blocking ability of the heat-insulating energy-saving film. In addition, when the second bonding layer is formed from an acrylic based pressure sensitive adhesive, the heat-insulating energy-saving film can have an explosion-proof ability in practical applications.

The heat-insulating energy-saving film of the present disclosure can reduce the effect of an outdoor environment on an indoor temperature under irradiation of strong sunlight, and therefore it contributes greatly to energy saving and carbon footprint reduction. In addition, the heat-insulating energy-saving film of the present disclosure is easy to be used and reworked.

[Antifouling Property and External Impact Resistance Tests]

TABLE 1

| | | | Antifouling |
|---|---|---|---|
| | | External impact | property |
| | Functional | resistance | Water contact |
| | layer | Pencil hardness | angle |
| Example 1 | PVDF | HB | 89.0 |
| Example 2 | PTFE | B | 109.2 |
| Example 3 | PVDF(PTFE)/PMMA | 1H | 82.3 |
| Comparative | PE | 2B | 96 |
| Example 1 | | | |
| Comparative | PMMA | 2H | 70.9 |
| Example 2 | | | |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A heat-insulating energy-saving film, comprising:
a substrate having a first surface and a second surface opposite to the first surface;
an infrared blocking layer disposed on the first surface of the substrate and having a plurality of composite tungsten oxide particles uniformly distributed therein, the composite tungsten oxide particles having the following formula of: CsₓM_{y}WO_{3-z}N_{c}, wherein Cs represents cesium, M represents tin (Sn), antimony (Sb) or bismuth (Bi), W represents tungsten, O represents oxygen, and N represents fluorine (F), chlorine (Cl) or bromine (Br); and
an antifouling protective layer disposed on the infrared blocking layer.

2. The heat-insulating energy-saving film according to claim 1, wherein the antifouling protective layer contains 40% to 90% by weight of a fluoropolymer that is at least one selected from of polyvinylidene fluoride, polytetrafluoroethylene and polyvinyl fluoride.

3. The heat-insulating energy-saving film according to claim 1, wherein the antifouling protective layer contains 0.3% to 15% by weight of a colorant.

4. The heat-insulating energy-saving film according to claim 1, wherein the average particle diameter of the composite tungsten oxide particles is between 10 nm and 90 nm, and the composite tungsten oxide particles are present in an amount between 5% and 25% by weight of the total weight of the infrared blocking layer.

5. The heat-insulating energy-saving film according to claim 1, wherein the substrate is formed from a polyester resin, and the infrared blocking layer is formed from a UV-curable resin composition with the composite tungsten oxide particles.

6. The heat-insulating energy-saving film according to claim 1, wherein the substrate has a thickness between 23 μm and 125 μm, the infrared blocking layer has a thickness between 2 μm and 10 μm, and the antifouling protective layer has a thickness between 12 μm and 50 μm.

7. The heat-insulating energy-saving film according to claim 1, further comprising a first bonding layer disposed between the infrared blocking layer and the antifouling protective layer, and the antifouling protective layer is fixed in position to the infrared blocking layer by the first bonding layer.

8. The heat-insulating energy-saving film according to claim 7, wherein the first bonding layer has a thickness between 5 μm and 25 μm.

9. The heat-insulating energy-saving film according to claim 7, wherein the first bonding layer contains 2% to 10% by weight of an ultraviolet absorber.

10. The heat-insulating energy-saving film according to claim 1, further comprising a second bonding layer disposed on the second surface of the substrate.

11. The heat-insulating energy-saving film according to claim 10, wherein the second bonding layer has a thickness between 5 μm and 25 μm.

12. The heat-insulating energy-saving film according to claim 10, wherein the second bonding layer contains 0.5% to 8% by weight of an ultraviolet absorber.
